(19) United States
(12) Patent Application Publication
(10) Pub. No.: US 2010/0054508 A1
(43) Pub. Date: Mar. 4, 2010

(54) MULTIPLE-CHANNEL DIGITAL SOUND FIELD WIRELESS EARPHONE DEVICE

(75) Inventor: Bill Yang, Taipei City (TW)

Correspondence Address: J C PATENTS, 4 VENTURE, SUITE 250, IRVINE, CA, 92618, US

(73) Assignee: COTRON CORPORATION, Taipei City (TW)

(21) Appl. No.: 12/271,561

(22) Filed: Nov. 14, 2008

(30) Foreign Application Priority Data
Sep. 1, 2008 (TW) 97215717

(51) Int. Cl. H04R 5/02

(52) U.S. Cl. 381/310

(57) ABSTRACT

A digital wireless earphone device with stereo or multiple-channel sound effect automatic detection and switching functions is provided. The multiple-channel digital wireless earphone device uses a signal processing and transmitting device to decode multiple-channel signal sources. After the decoding is completed, the multiple-channel signal sources are concurrently transmitted to a wireless earphone end through a radio. After being directly digital-to-analog converted and amplified, the multiple-channel signals are connected to a plurality of speakers to generate a multiple-channel surround sound field. The wireless earphone at a receiving end further has an automatic detection function for detecting a 6CH or 2CH sound source and automatically selects an earphone playing mode accordingly.

### CROSS-REFERENCE TO RELATED APPLICATION

This application claims the priority benefit of Taiwan application serial no. 97215717, filed on Sep. 1, 2008. The entirety of the above-mentioned patent application is hereby incorporated by reference herein and made a part of specification.

### BACKGROUND OF THE INVENTION

1. Field of the Invention

The present invention generally relates to a multiple-channel wireless earphone device, and more particularly to a wireless earphone device with a stereo or multiple-channel sound effect automatic detection and switching functions.

2. Description of Related Art

With the rapid development of digital technologies, the entertainments in people's daily life has also gradually become more digitized. For example, a Digital Versatile Disc (DVD) player has been a common video playback device in most families. As most DVD players have equipped with Dolby Digital or Digital Theater System (DTS) decoding function, the DVD players can be used to decode digital signals, and output analog signals to multiple-channel amplifiers, so as to enable 5.1 channel speaker systems to produce sounds.

A multiple-channel amplifier and speakers are indispensable for realizing a high-quality digital audio-visual entertainment. The 5.1-channel speakers are the most basic multiple-channel speakers.

Generally, in a home theater system including a 5.1-channel amplifier and speakers, when the DVD player plays audio-visual programs, the amplifier amplifies different sound signals and outputs them to main front left and right speakers, center speaker, surround (or rear) left and right speakers, and sub woofer respectively, so as to produce a three-dimensional sound effect that sounds real to the audience.

However, in the case that the speakers cannot be used (for example, the sounds produced by the speakers may influence somebody else who are doing their work), then an earphone is needed. As the earphone must be connected to a playback device via a wire to transmit signals, the movement of the listener is limited, that is, the listener cannot move around freely.

In U.S. Pat. No. 6,614,912 and U.S. Pat. No. 6,928,179, an infrared wireless earphone is disclosed. The operating principles thereof are described as follows: a multiple-channel sound effect is processed into signals of left and right channels through a signal processing procedure, and then the signals are transmitted to the earphone wirelessly, and then two speakers in the earphone are used to present a virtual multiple-channel sound effect. However, the virtual sound effect generated by such architecture is not a real multiple-channel effect. In addition, the transmission distance of the infrared wireless technology is rather short, and the infrared rays cannot penetrate objects that blocks the way, which further restricts the transmission range.

In U.S. Patent Publication No. 2006/0287745, a wireless audio system using infrared transmission is provided. The wireless audio system is mainly used to select from a plurality of sound sources, decode the received signals, and generate a multiple-channel sound effect. However, the earphone must be configured with decoders for a plurality of sound sources at the same time, so the structure thereof is very complicated. In addition, when the received signals are processed, the signal delays for different signals must be considered, for example, when the high-quality signals of the 5.1-channel sound source are processed, the delay problem may occur. Furthermore, as the infrared transmission is adopted, the transmission distance is also restricted. Therefore, such disclosure is limited to a wireless audio system applied in an automobile.

In addition, in the Taiwan Patent Application No. 200603652, a multiple-channel wireless audio system is provided, which includes a receiving unit for receiving and demodulating wireless multiple-channel sound signals. In this patent application, a receiving circuit is added at an earphone end, and after a signal is obtained through demodulation and spread spectrum methods, the multiple-channel sound signal is decoded to a plurality of signals of different channels by a decoder. Then, a sound mixer and signal processor mixes and processes the signals of different channels to generate a plurality of mixed sound signals with different stereo effects, which are then sent to speakers to produce sounds. Though this architecture achieves a desirable wireless transmission range, the signal transmission becomes rather complicated. Moreover, the received demodulated signals must be decoded by the decoder, and during this process, the signal content of the 5.1-channel sound source may not be effectively decoded due to transmission errors, which relatively influences the quality of signal transmission. Besides, if the functions of the earphone end are too complicated, the earphone end cannot meet the design requirements of being light, thin, short, and small.

The design of the multiple-channel wireless earphone device must be capable of eliminating the limitations caused by topographic features and objects within the effective wireless transmission range of signals, and must have a high noise tolerance to the transmitted content. Furthermore, the modern design requirements of being light, thin, short, and small must be considered as well.

### SUMMARY OF THE INVENTION

Accordingly, the present invention is directed to a multiple-channel digital wireless earphone device, and more particularly to a wireless digital earphone device with stereo or multiple-channel sound effect automatic detection and switching functions.

As embodied and broadly described herein, a multiple-channel digital wireless earphone device is provided in the present invention, in which multiple-channel signal sources are decoded at a transmitting end, and then they are transmitted to an earphone end through a radio. After being digital-to-analog converted and amplified, the multiple-channel signals are connected to a plurality of speakers to generate a multiple-channel surround sound field. Furthermore, the earphone device at a receiving end meets the requirements of being light, thin, short, and small.

A multiple-channel digital wireless earphone device is provided in the present invention, which can automatically detect received sound source signals, determine whether the sound source signals are 6CH or 2CH, and automatically select a corresponding earphone playing mode. If the sound source signals are 6CH, that is, a 5.1-channel surround sound effect, signals of different channels are respectively connected to the main front speakers, sub woofers, center speaker, and surround speakers in the multiple-channel earphone. Furthermore, if the sound source signals are 2CH, that is, a stereo sound effect, the signals are concurrently connected to the main front left and right speakers, and left and right sub woofers, or a combination of a plurality of other speakers, instead of being merely connected to the main front speakers, thereby achieving different sound field effects.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic block diagram of the architecture of a signal transmitting device serving as a transmitting end in a multiple-channel wireless earphone device according to the present invention.

FIG. 2 is a schematic block diagram of the architecture of a wireless earphone serving as a receiving end in the multiple-channel wireless earphone device according to the present invention.

FIGS. 3A-3D are schematic views of a signal processing and receiving device in the multiple-channel wireless earphone device according to the present invention.

FIGS. 4A-4D show a wireless earphone including a receiving device to act as a receiving end of the multiple-channel wireless earphone device according to the present invention.

FIGS. 5A-5D are schematic views of receiving device in a multiple-channel wireless earphone device according to another embodiment of the present invention.

Reference will now be made in detail to the present embodiments of the invention, examples of which are illustrated in the accompanying drawings. Wherever possible, the same reference numbers are used in the drawings and the description to refer to the same or like parts.

### DESCRIPTION OF THE EMBODIMENTS

Besides eliminating the limitations caused by topographic features and objects within the effective wireless transmission range of signals, the design of the multiple-channel digital wireless earphone device is further required to have a high noise tolerance to the transmitted content. Furthermore, the modern design requirements of being light, thin, short, and small must be considered as well.

In the multiple-channel digital wireless earphone device of the present invention, multiple-channel signal sources are decoded at a transmitting end, and then they are transmitted to an earphone end wirelessly. After being directly digital-to-analog converted and amplified, the multiple-channel signal sources are connected to a plurality of speakers to generate a multiple-channel surround sound field. Furthermore, the earphone device at a receiving end meets the requirements of being light, thin, short, and small.

The multiple-channel wireless earphone device of the present invention is suitable for being connected to a 5.1-channel sound source (briefly called 6CH sound source hereinafter) output by a Digital Versatile Disc (DVD) player or connected to a stereo sound source (briefly called 2CH sound source hereinafter).

For example, when the earphone device receives the 6CH sound source digitally output by the DVD player or provided by a video game console, a decoding circuit in the transmitter decodes the 6CH sound source, and wirelessly transmits the 6CH sound source to 5.1-channel earphones in a digital manner for playback. The output signals include three groups of signal sources, for example, front signals, rear signals, and a center signal/a sub woofer signal.

However, when the received signals are 2CH stereo sound source, for example, signals of the 2CH sound source provided by the DVD player, or a sound source in a linear pulse code modulation (LPCM) format, the multiple-channel digital wireless earphone device of the present invention concurrently connects the amplified signals to at least two groups of speakers in the multiple-channel earphone for playback. Based on different combinations of the speakers in the multiple-channel earphone, a sound with the sound field separation effect is generated, such that the original 2CH stereo sound source produces different sound field effects.

The multiple-channel digital wireless earphone device of the present invention can automatically detect received sound source signals, determine whether the sound source signals are 6CH or 2CH, and automatically select a corresponding earphone playing mode accordingly. If the sound source signals are 6CH, that is, a 5.1-channel surround sound effect, signals of different channels are respectively connected to main front speakers, sub woofers, central speaker, and surround speakers in the multiple-channel earphone. Furthermore, if the sound source signals are 2CH, that is, a stereo sound effect, the signals are concurrently connected to main front left and right speakers and left and right sub woofers or a combination of a plurality of other speakers, instead of being merely connected to the main front speakers, thereby achieving different sound field effect.

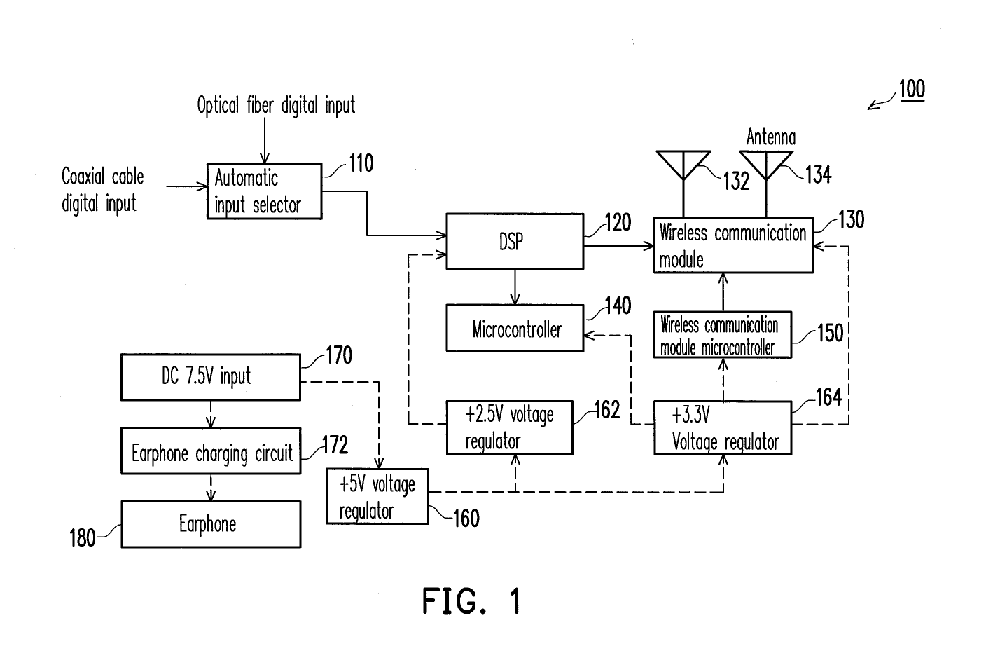

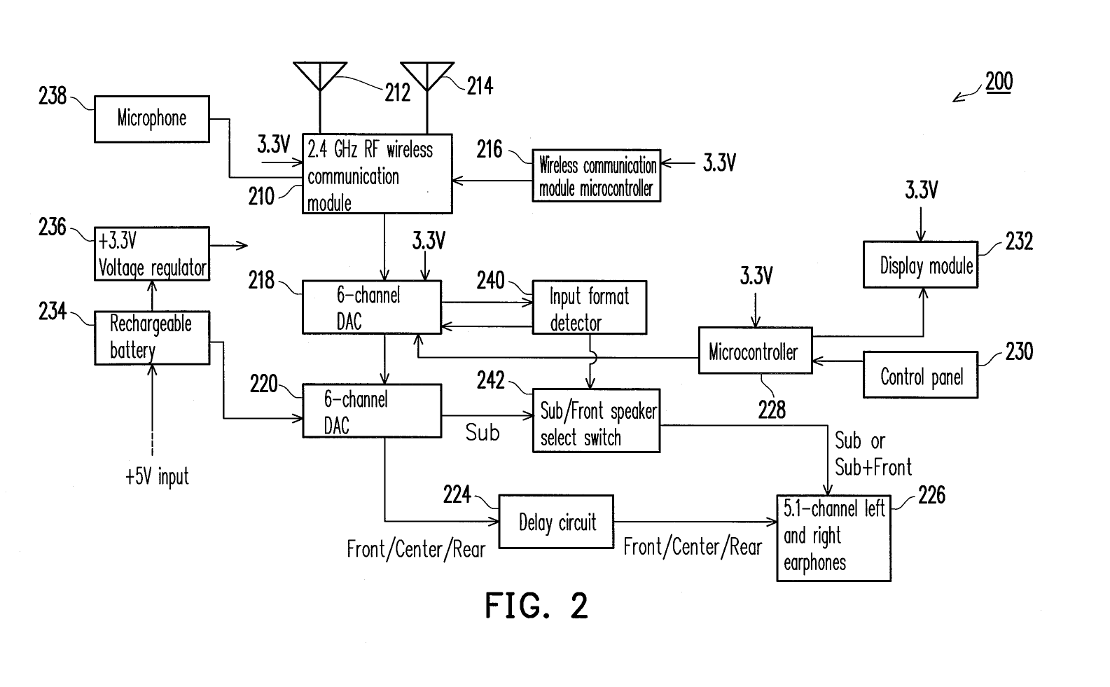

The multiple-channel wireless earphone device of the present invention includes a signal processing and transmitting device and a wireless earphone with a receiving device. An embodiment of the present invention is described below with reference to FIGS. 1 and 2.

FIG. 1 is a schematic circuit diagram of a signal processing and transmitting device in a multiple-channel wireless earphone device according to the present invention. The signal processing and transmitting device 100 includes an automatic input selector 110, a digital signal processor (DSP) 120, a wireless communication module 130, a microcontroller 140, a wireless communication module microcontroller 150, and voltage regulators 160, 162, and 164 with different output voltages. Furthermore, the signal processing and transmitting device further includes a DC voltage input 170 and an earphone charging circuit 172 for charging a wireless earphone 180. The wireless earphone 180 is the wireless earphone including a receiving device according to the present invention, which employs a rechargeable battery charged by the earphone charging circuit 172 in a charging mode of electrical contact or electromagnetic induction.

In the signal processing and transmitting device 100, the automatic input selector 110 has a coaxial circuit connection interface and an optical fiber connection interface, which are respectively connected to a coaxial digital signal input source from a coaxial circuit and an optical fiber digital signal input source from an optical circuit. The automatic input selector 110 can detect and automatically switch between digital signal sources, and output the received signals to the DSP 120.

The optical fiber connection interface may be in the Sony/Philips Digital Interface (S/PDIF) format, in which an optical fiber connection circuit satisfying the S/PDIF specifications connects signals to a multiple-channel decoder to generate a surround sound field effect such as Dolby Digital and Digital Theater System (DTS) or a stereo sound field effect. Dolby Digital and DTS are both multiple-channel audio formats widely applied in 5.1-channel audio systems currently. The S/PDIF format with the full name of Sony/Philips Digital Interface is a specification developed under the cooperation of both Sony and Philips. The S/PDIF includes two connection types. The first type uses an unbalanced RCA connector and 75-ohm coaxial signal cables, and the second type uses optical fibers. The S/PDIF is the most common digital signal format in home specifications, for example, digital audio recording and playing of Mini Disk (MD) and surround digital output of DVD players. In this embodiment, the S/PDIF connection port is used.

The DSP 120 is responsible for decoding the multiple-channel digital sound effect. The DSP 120 includes built-in decoding software, for processing Dolby Digital 5.1, Dolby Digital 2.0, Dolby Pro Logic, LPCM (stereo), or DTS encoded signals to output multiple-channel signals. The multiple-channel signals include three groups, for example, front signals, rear signals, and a center signal and sub woofer signal. In the multiple-channel wireless earphone device of the present invention, the DSP 120 at the transmitting end decodes the signals, and connects the obtained three groups of digital signals (including: 1. the front signals, 2. the rear signals, and 3. the center signal and sub woofer signal) to the wireless communication module 130, in which the three groups of signals are transmitted concurrently over a group of antennas 132 and 134. For example, the wireless communication module 130 may be a 2.4 GHz RF radio transmitter.

The signal processing and transmitting device 100 further includes the microcontroller 140 and the wireless communication module microcontroller 150, which control the operations of the DSP 120 and the wireless communication module 130 respectively. In addition, the voltage regulator 160 obtains a DC voltage source from the DC voltage input 170, for example, a 7.5 V voltage as shown in FIG. 1, and then converts the 7.5 V voltage into a 5 V voltage and outputs the 5 V voltage to the voltage regulators 162 and 164, where the 5 V voltage is respectively converted into a 2.5 V voltage and a 3.3 V voltage output.

The receiving end of the multiple-channel wireless earphone device according to the present invention is a wireless earphone containing a receiving device. FIG. 2 is a schematic structural view of a wireless earphone 200. Referring to FIG. 2, the wireless earphone 200 includes a wireless communication module 210, a group of antennas 212 and 214, and a wireless communication module microcontroller 216. Moreover, the wireless earphone 200 further includes a 6-channel digital-to-analog converter (DAC) 218, a 6-channel earphone amplifier 220, a delay circuit 224, and 5.1-channel left and right earphones 226. In addition, the wireless earphone 220 further includes a microcontroller 228, a control panel 230, a display module 232, and a voltage regulator 236.

The operating voltage of the wireless communication module 210, the wireless communication module microcontroller 216, the 6-channel DAC 218, the microcontroller 228, and the display module 232 are supplied by the +3.3V voltage regulator 236. The voltage source of the +3.3V voltage regulator 236 is the rechargeable battery 234, which may be charged by the earphone charging circuit 172 as shown in FIG. 1. The working voltage of the 6-channel earphone amplifier 220 is directly supplied by the rechargeable battery 234.

To accomplish the function of automatically detecting the 6CH and 2CH sound sources, the present invention further includes an input format detector 240 and a sub/front speaker select switch 242 in an alternative embodiment.

The wireless communication module 210 works together with the wireless communication module 130 of the signal processing and transmitting device 100 to transmit and receive signals. When the wireless communication module 130 transmits the three groups of digital signals including the front signals, the rear signals, and the center signal and the sub woofer signal through an RF radio at a frequency band of 2.4 GHz, the wireless communication module 210 uses its own 2.4 GHz RF radio receiver to receive the three groups of signals concurrently, and connects them to the 6-channel DAC 218.

In this embodiment, as the wireless earphone 200 may be optionally provided with a microphone 238, the earphone 200 must further include a radio transmitter, besides the radio receiver. The wireless communication module 130 shown in FIG. 1 must include both a radio receiver and a radio transmitter at the same time, that is, a radio transceiver, so as to receive signals from the microphone 238 of the wireless earphone 200.

The 6-channel DAC 218 is mainly used to convert the three groups of digital signals including the front signals, the rear signals, and the center signal and the sub woofer signal into analog signals.

The microcontroller 228 is responsible for setting a working mode for the 6-channel DAC 218, including volume control and status monitoring, and informing messages such as decoder volume setting and decoding format to the user through the display module 232. The control panel 230 offers various options, such as main volume control, volume control of the center channel and surround channels, volume reset, and mute.

The 6-channel earphone amplifier 220 amplifies the analog signal outputs from the 6-channel DAC 218 to drive the 5.1-channel earphones. The delay circuit 224 blocks the surge current from the amplifier to the speakers generated at the instance when the earphone is powered on, so as to protect the user's ears from being hurt.

The input format detector 240 determines whether the music format is 5.1-channel format or stereo format, and generates a control signal to the sub/front speaker select switch 242 according to the music format, so as to control and adjust the speaker configuration, thereby achieving the best audio effect. The sub/front speaker select switch 242 connects the bass to the left and right sub woofers when the input sound source is in the 5.1-channel format. When the input sound source is in the stereo format, the left front and right front outputs are respectively connected to the left and right sub woofers, so as to enhance the effect of the stereo music. At this time, the center and rear surround channels have no output.

The multiple-channel wireless earphone device of the present invention may adopt a design of a non-fixed microphone, which is connected to the earphone device, for example, through a jack. For example, the connection jack between the microphone and the earphone device is a conductive device, the microphone is a gooseneck microphone, and a connecting end of the microphone may be directly inserted into the jack, so as to establish the electrical connection there-between.

In addition, the microphone 238 and the wireless earphone 200 may also be fixed together by adding a magnet to the connection interface, so as to attract and fix the microphone 238 on the wireless earphone 200. When the microphone 238 is not used, it can be removed from the wireless earphone 200.

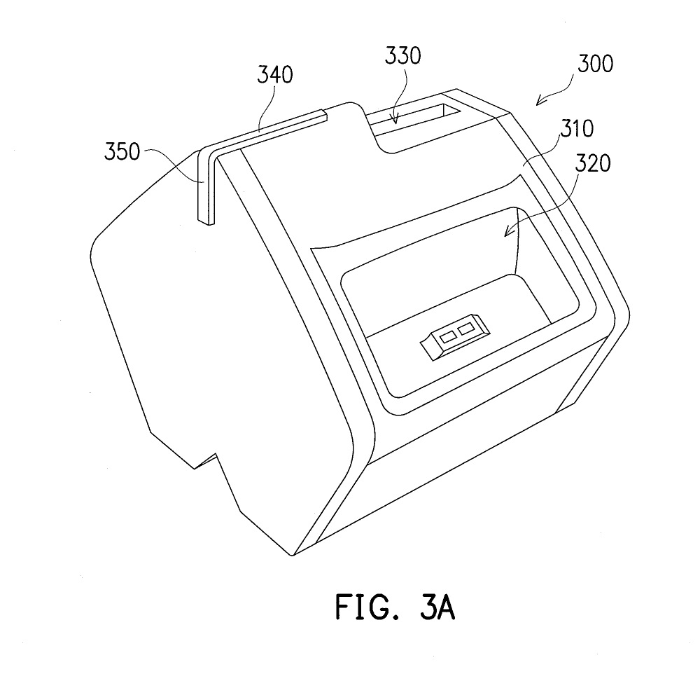

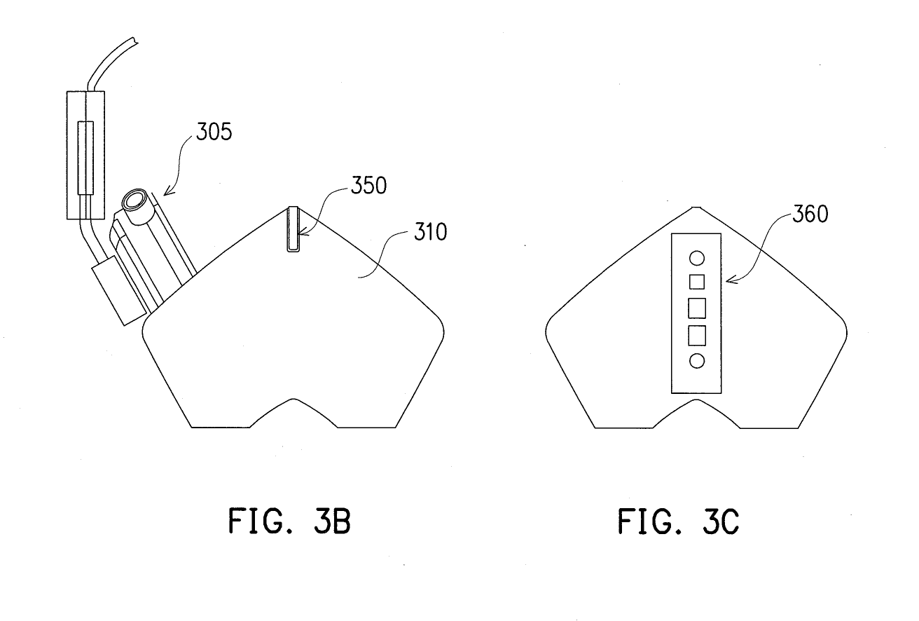

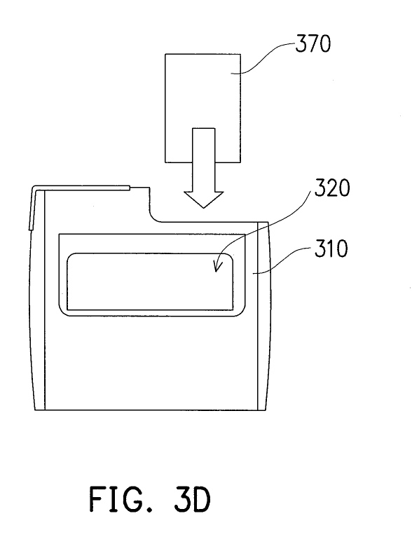

FIGS. 3A-3D are schematic views of a signal processing and transmitting device in the multiple-channel wireless earphone device according to the present invention. Referring to FIGS. 3A-3D, the signal processing and transmitting device 300 includes an automatic input selector, a DSP, a wireless communication module, a microcontroller, a wireless communication module microcontroller, voltage regulators with different voltage outputs, and an earphone charging circuit and the like. These components have the same functions as those of FIG. 1, and will not be described here again.

In addition, two grooves 320 for accommodating a wireless earphone 305 are disposed on a body 310 of the signal processing and transmitting device 300. A connection interface 322 for electrically connecting the wireless earphone 305 is disposed in each groove, for example, the connection interface 322 is a plurality of pins. In addition, the signal processing and transmitting device 300 further includes a battery slot 330, which is provided for a battery 370 to be inserted therein and supplies power to the battery 370, and it is equivalent to the DC voltage input 170 of FIG. 1. Certainly, the DC voltage input is not limited to a rechargeable battery, which may be an external adapter.

Two indicators 340 and 350 are disposed on one side of the body 310. The indicator 340 indicates a charging status of the wireless earphone 305, and the indicator 305 indicates whether the power is supplied or not currently. The indicators 340 and 350 may be light-emitting diode (LED) display devices. A connection interface 360 is disposed on the other side of the body 310. The connection interface includes a plurality of connection jacks for connecting different sound sources, for example, an optical fiber connection interface in the S/PDIF format, or a coaxial signal cable interface with an unbalanced RCA connector. In addition, a universal serial bus (USB) connection interface, for example, may also be used to connect signals.

When the two earphone ends of the wireless earphone 305 are respectively accommodated into the grooves 320, the wireless earphone 305 may be charged by the earphone charging circuit in the signal processing and transmitting device 300. Here, the charging mode of electrical contacts is introduced. Certainly, the charging mode of electromagnetic induction may also be adopted.

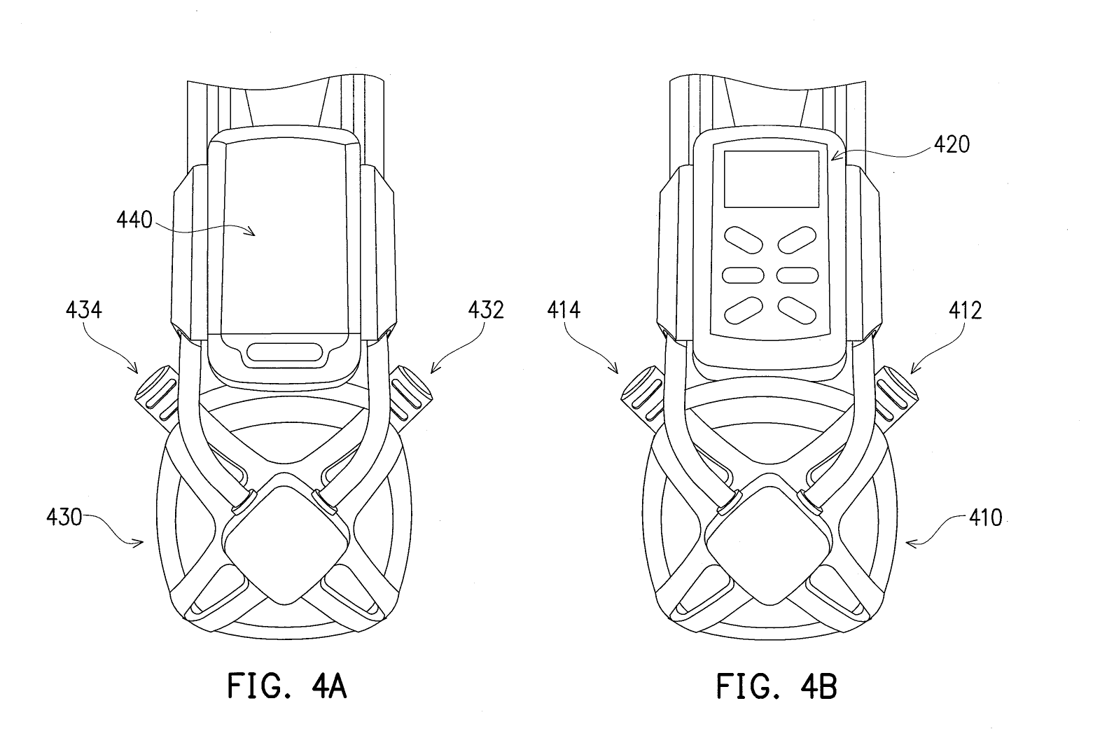

FIGS. 4A-4D show a wireless earphone including a receiving device to serve as a receiving end of the multiple-channel wireless earphone device according to the present invention. FIGS. 4A and 4B are schematic side views of the wireless earphone on one side, and FIGS. 4C and 4D are schematic side views of the wireless earphone on the other side. The wireless earphone includes 5.1-channel left and right earphones 410 and 430. The portion above the left and right earphones 410 and 430 wearing on the user's head includes a wireless communication module 420 and a battery 440. A set of antennas and a wireless communication module microcontroller are disposed within the wireless earphone. In addition, the wireless earphone further includes a 6-channel DAC, a 6-channel earphone amplifier, a delay circuit, a microcontroller, and voltage regulators. The structure is similar to that of FIG. 2, and will not be described herein again. In addition, the wireless communication module 420 further includes a control panel 424 and a display module 422.

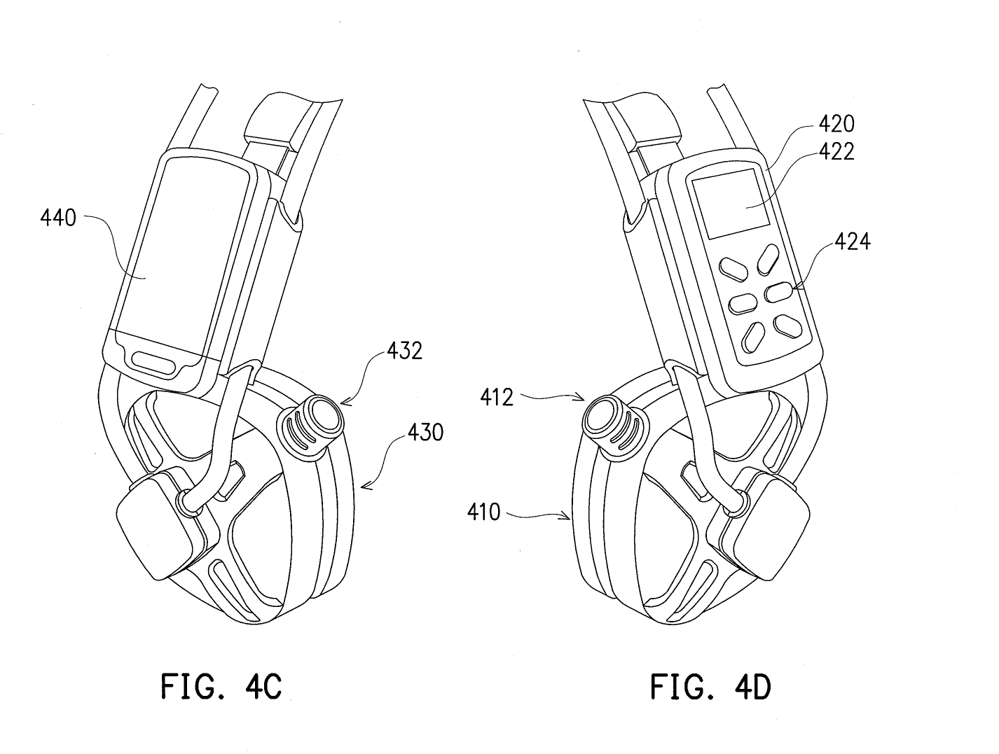

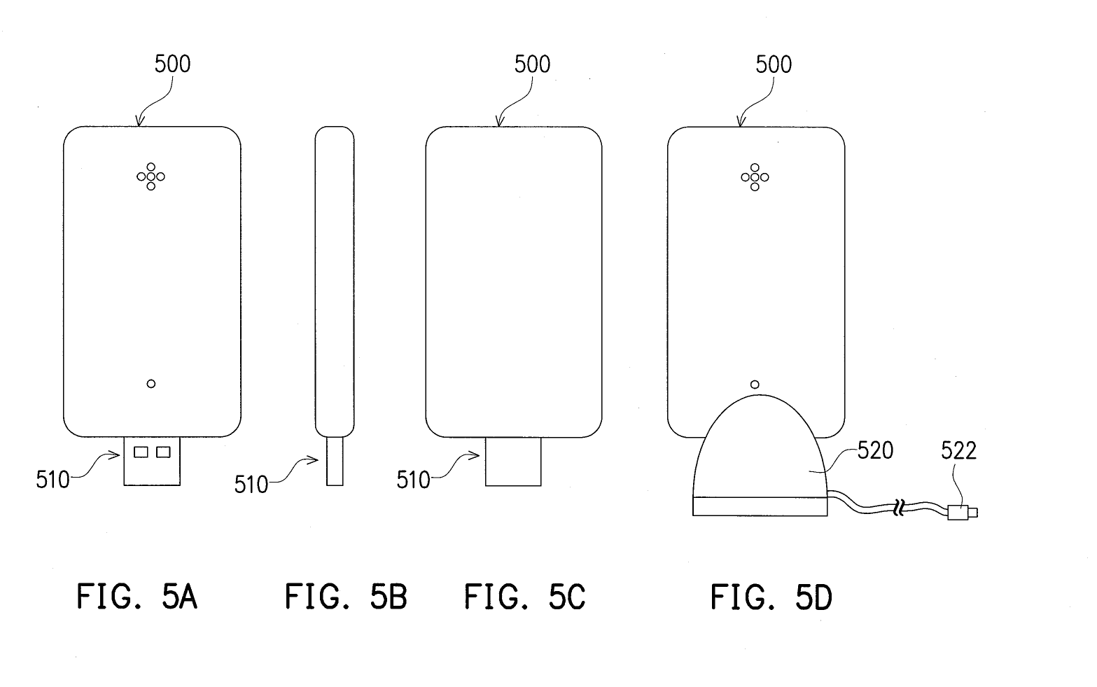

FIGS. 5A-5C are schematic views of a signal processing and transmitting device in a multiple-channel wireless earphone device according to another embodiment of the present invention. Referring to FIGS. 5A-5C, the signal processing and transmitting device 500 includes a USB audio controller, a DAC, a wireless communication module, a wireless communication module microcontroller, and voltage regulators with different voltage outputs. The functions of these components are the same as those of FIG. 1, and will not be described here again. The most important difference between the signal processing and transmitting device 500 and the previous corresponding signal processing and transmitting device in the above embodiment lies in that, the signal processing and transmitting device 500 is directly connected to a USB audio source through a USB port 510, in which the USB audio source is generally a computer device, including a personal computer (PC) or a laptop, and then connects the multiple-channel sound source signals of the computer to the wireless earphone after performing the digital-to-analog conversion on the signals. Furthermore, as shown in FIG. 5D, the signal processing and transmitting device 500 may be connected to an external audio source through a USB cable.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A multiple-channel wireless earphone device, comprising:
a signal processing and transmitting device, for decoding a multiple-channel digital sound effect, generating a plurality of groups of digital sound source signals, and transmitting the plurality of the digital sound source signals to a multiple-channel wireless earphone concurrently through wireless communication; and
a wireless earphone, directly receiving the plurality of the digital sound source signals through wireless communication, and generating a multiple-channel sound field through a plurality of groups of speakers of the wireless earphone after performing digital-to-analog conversion and amplification on the digital sound source signals.

2. The multiple-channel wireless earphone device according to claim 1, wherein the signal processing and transmitting device comprises:
a digital signal processor, for decoding the multiple-channel digital sound effect, and generating the digital sound source signals; and
a first wireless communication module, for concurrently transmitting the digital sound source signals through wireless communication.

3. The multiple-channel wireless earphone device according to claim 2, wherein the digital signal processor generates the digital sound source signals with a surround sound field effect.

4. The multiple-channel wireless earphone device according to claim 3, wherein the surround sound field effect satisfies one of formats of Dolby Digital 5.1, Dolby Digital 2.0, Dolby Pro Logic, or Digital Theater System (DTS) encoded signals.

5. The multiple-channel wireless earphone device according to claim 2, wherein the digital signal processor generates the digital sound source signals with a stereo sound field effect.

6. The multiple-channel wireless earphone device according to claim 5, wherein the stereo sound field effect satisfies a linear pulse code modulation (LPCM) (stereo) format.

7. The multiple-channel wireless earphone device according to claim 1, wherein the first wireless communication module of the signal processing and transmitting device is a radio frequency (RF) communication module.

8. The multiple-channel wireless earphone device according to claim 2, wherein the digital signal processor of the signal processing and transmitting device decodes the multiple-channel digital sound effect, generates three groups of digital signals comprising front signals, rear signals, and a center signal and a sub woofer signal, and connects the three groups of digital signals concurrently through the first wireless communication module.

9. The multiple-channel wireless earphone device according to claim 8, wherein the first wireless communication module transmits the digital signals through an RF radio in a 2.4 GHz frequency band by using a pair of antennas.

10. The multiple-channel wireless earphone device according to claim 1, wherein the wireless earphone further comprises a non-fixed microphone electrically connected to the wireless earphone detachably, for inputting a sound of a user, and transmitting the sound to the signal processing and transmitting device through the wireless earphone.

11. The multiple-channel wireless earphone device according to claim 1, wherein the signal processing and transmitting device is connected to sound source signals through an optical fiber connection interface in an S/PDIF format to generate the plurality of groups of digital sound source signals.

12. The multiple-channel wireless earphone device according to claim 1, wherein the signal processing and transmitting device is connected to sound source signals through a coaxial signal cable connection interface using an unbalanced RCA connector to generate the plurality of groups of digital sound source signals.

13. The multiple-channel wireless earphone device according to claim 1, wherein the signal processing and transmitting device comprises two grooves for accommodating and charging the wireless earphone.

14. The multiple-channel wireless earphone device according to claim 13, wherein a connection interface is disposed in the two grooves, for electrically connecting and charging the wireless earphone, when the wireless earphone is accommodated in the grooves.

15. The multiple-channel wireless earphone device according to claim 13, wherein when the wireless earphone is accommodated in the grooves, an electromagnetic charging mode is adopted.

16. The multiple-channel wireless earphone device according to claim 1, wherein the signal processing and transmitting device is connected to sound source signals through a universal serial bus (USB) connection interface to generate the plurality of groups of digital sound source signals.

17. The multiple-channel wireless earphone device according to claim 1, wherein the wireless earphone comprises:
a pair of multiple-channel earphones;
a second wireless communication module, for receiving the digital sound source signals through wireless communication;
a multiple-channel digital-to-analog converter, for receiving the digital sound source signals obtained through wireless communication, and converting the digital sound source signals into analog signals;
a multiple-channel earphone amplifier, connected to the multiple-channel digital-to-analog converter, for receiving the analog signals, and outputting a group of front signals, a group of surround signals, a center signal, and a sub woofer signal accordingly;
an input format detector, connected to the multiple-channel digital-to-analog converter, for determining a format of a decoded signal, and outputting a control signal according to the format;
a delay device, for receiving the group of front signals, the group of surround signals, the center signal and the sub woofer signal, delaying the signals, and outputting the signals to the multiple-channel earphone, so as to protect listener's eardrums from being hurt by a impulse generated when the multiple-channel earphone is powered on; and
a sub/front speaker select switch, connected to the input format detector and the delay device, for receiving the group of front signals and the sub woofer signal output by the delay device, and switching the front signals and the sub woofer signal according to the control signal, wherein when the group of front signals is received but no surround signals and sub woofer signal are received, the sub/front speaker select switch immediately cuts off a sub woofer output, and outputs the group of front signals to left and right sub woofers in the multiple-channel earphone, so as to enhance a stereo effect.

18. The multiple-channel wireless earphone device according to claim 1, wherein the wireless earphone further comprises a control panel for controlling an operating status of the wireless earphone.

19. The multiple-channel wireless earphone device according to claim 18, wherein the operating status comprises one of controlling a main volume, controlling volumes of a center channel and surround channels, or resetting a volume.

20. The multiple-channel wireless earphone device according to claim 1, wherein the wireless earphone further comprises a display module for displaying a volume setting or decoding format of the wireless earphone.
